(19) United States
(12) Patent Application Publication
(10) Pub. No.: US 2013/0331027 A1
(43) Pub. Date: Dec. 12, 2013

(54) COMMUNICATIONS SYSTEM PROVIDING REMOTE ACCESS VIA MOBILE WIRELESS COMMUNICATIONS DEVICE AND RELATED METHODS

(71) Applicants: SCOTT DOUGLAS ROSE, WATERLOO (CA); VAHID MOOSAVI, KITCHENER (CA); MICHAEL JOHN ROGAN, KITCHENER (CA)

(72) Inventors: SCOTT DOUGLAS ROSE, WATERLOO (CA); VAHID MOOSAVI, KITCHENER (CA); MICHAEL JOHN ROGAN, KITCHENER (CA)

(73) Assignee: RESEARCH IN MOTION LIMITED, WATERLOO (CA)

(21) Appl. No.: 13/491,877

(22) Filed: Jun. 8, 2012

(51) Int. Cl. G05B 19/02; H04B 7/26; H04B 5/02

(52) U.S. Cl. 455/41.1

(57) ABSTRACT

A mobile wireless communications device may include a first wireless transceiver, a second wireless transceiver having a longer communication range than the first wireless transceiver, and a controller coupled with the first wireless transceiver and the second wireless transceiver. The controller may be capable of transmitting, via the first wireless transceiver, an access request to an access control device associated with an access position, and receive a first identifier from the access control device based upon the access request. The controller may be further capable of transmitting, via the second wireless transceiver, an authentication request to an authentication server based upon the first identifier and a second identifier associated with the mobile wireless communications device, and receive an authentication response based upon the authentication request. The controller may also be capable of transmitting, via the first wireless transceiver, the authentication response to the access control device.

### TECHNICAL FIELD

This application relates to the field of communications, and more particularly, to electronic devices and related methods that use near-field communication (NFC).

### BACKGROUND

Mobile communication systems continue to grow in popularity and have become an integral part of both personal and business communications. Various mobile devices now incorporate Personal Digital Assistant (PDA) features such as calendars, address books, task lists, calculators, memo and writing programs, media players, games, etc. These multi-function devices usually allow electronic mail (email) messages to be sent and received wirelessly, as well as access the Internet via a cellular network and/or a wireless local area network (WLAN), for example.

Some mobile devices incorporate contactless card technology and/or near field communication (NEC) chips. NEC technology may be used for contactless short-range communications using magnetic field induction to enable communication between electronic devices, including mobile wireless communications devices. These short-range communications may include payment and ticketing, electronic keys, identification, device set-up service and similar information sharing. This short-range high frequency wireless communications technology may exchange data between devices over a short distance, such as only a few centimeters.

### BRIEF DESCRIPTION OF THE DRAWINGS

FIG. 1 is a schematic block diagram of an access system in accordance with one example embodiment.

FIG. 2 is a schematic block diagram of the mobile wireless communications device of the system of FIG. 1.

FIG. 3 is a flow diagram illustrating method aspects associated with the system of FIG. 1.

FIG. 4 is a diagram of an example embodiment of the system of FIG. 1 for a door key lock box.

FIG. 5 is a schematic block diagram illustrating example mobile wireless device components that may be used with the mobile wireless communications devices of FIGS. 1-3.

### DETAILED DESCRIPTION

The present description is made with reference to the accompanying drawings, in which exemplary embodiments are shown. However, many different embodiments may be used, and thus the description should not be construed as limited to the embodiments set forth herein. Rather, these embodiments are provided so that this disclosure will be thorough and complete. Like numbers refer to like elements throughout, and prime notation is used to indicate similar elements in different embodiments.

Generally speaking, a mobile wireless communications device is disclosed herein which may include a first wireless transceiver, a second wireless transceiver having a longer communication range than the first wireless transceiver, and a controller coupled with the first wireless transceiver and the second wireless transceiver. The controller may be capable of transmitting, via the first wireless transceiver, an access request to an access control device associated with an access position, and receive a first identifier from the access control device based upon the access request. The controller may be further capable of transmitting, via the second wireless transceiver, an authentication request to an authentication server based upon the first identifier and a second identifier associated with the mobile wireless communications device, and receive an authentication response based upon the authentication request. The controller may also be capable of transmitting, via the first wireless transceiver, the authentication response to the access control device. As such, access to the access position may be granted without the access control device having a direct communications link to the authentication server, since the mobile wireless communications device may instead perform the requisite authentication communications with the authentication server.

More particularly, the first wireless transceiver may include a near field communication (NFC) transceiver, a Bluetooth transceiver, etc., for example. Also by way of example, the second wireless transceiver may include a cellular transceiver. The controller may be capable of receiving the first identifier from the access control device along with an address of the authentication server, and sending the authentication request to the address.

By way of example, the controller may be capable of communicating with the authentication server via at least one of a Secure Sockets Layer (SSL) format or a Transport Layer Security (TLS) format. Furthermore, the authentication response may include a single-use security code. The authentication response may also have an expiration time associated therewith. The controller may be further capable of receiving an access denial electronic message from the authentication server via the second wireless transceiver based upon a validation failure.

A related access system may include an access control device associated with an access position, an authentication server, and a mobile wireless communication device, such as the one described briefly above. The mobile wireless communications device may be capable of transmitting, via the first wireless transceiver, an access request to the access control device. The access control device may be capable of transmitting a first identifier to the first wireless transceiver based upon the access request. The mobile wireless communications device may be capable of transmitting, via the second wireless transceiver, an authentication request to the authentication server based upon the first identifier and a second identifier associated with the mobile wireless communications device. The authentication server may be capable of authenticating the mobile wireless communications device responsive to the authentication request based upon the first identifier and the second identifier, and transmitting an authentication response to the second wireless transceiver based upon the authentication. The mobile wireless communications device may be capable of transmitting, via the first wireless transceiver, the authentication response to the access control device. The access control device may be capable of granting access to the access position based upon the authentication response. By way of example, the access control device may include a key lock box.

A related method of operating a mobile wireless communications device, such as the one described briefly above, may include transmitting, via the first wireless transceiver, an access request to an access control device associated with an access position, and receiving a first identifier from the access control device based upon the access request. The method may further include transmitting, via the second wireless transceiver, an authentication request to an authentication server based upon the first identifier and a second identifier associated with the mobile wireless communications device, and receive an authentication response based upon the authentication request. The method may also include transmitting, via the first wireless transceiver, the authentication response to the access control device.

A related non-transitory computer-readable medium may be for a mobile wireless communications device, such as the one described briefly above. The non-transitory computer-readable medium may include computer-executable instructions for causing the mobile wireless communications device to perform steps including transmitting, via the first wireless transceiver, an access request to an access control device associated with an access position, and receiving a first identifier from the access control device based upon the access request. Further steps may include transmitting, via the second wireless transceiver, an authentication request to an authentication server based upon the first identifier and a second identifier associated with the mobile wireless communications device, and receiving an authentication response based upon the authentication request. The steps may also include transmitting, via the first wireless transceiver, the authentication response to the access control device.

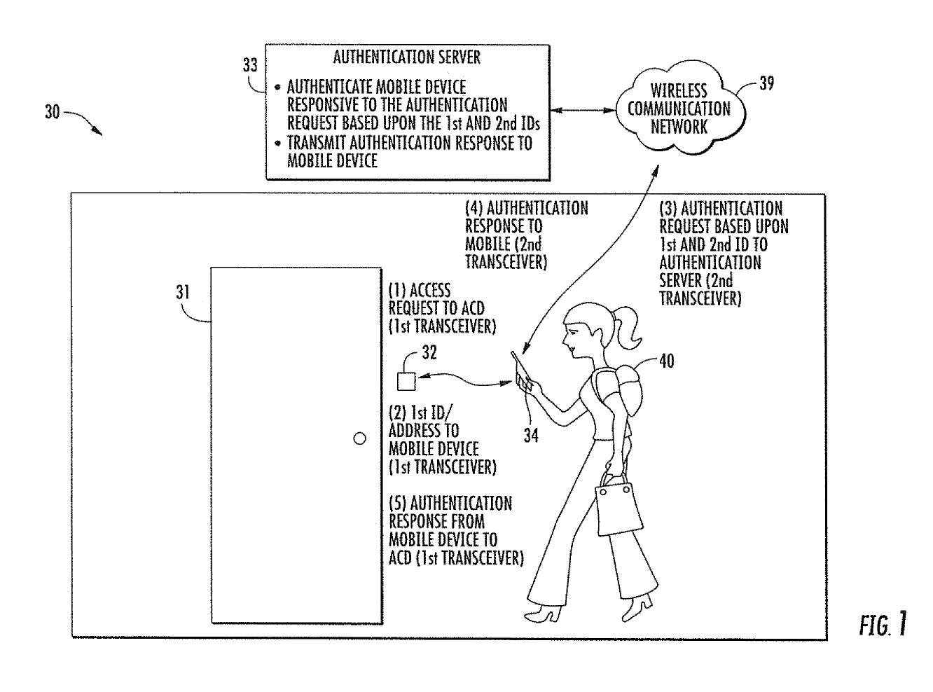

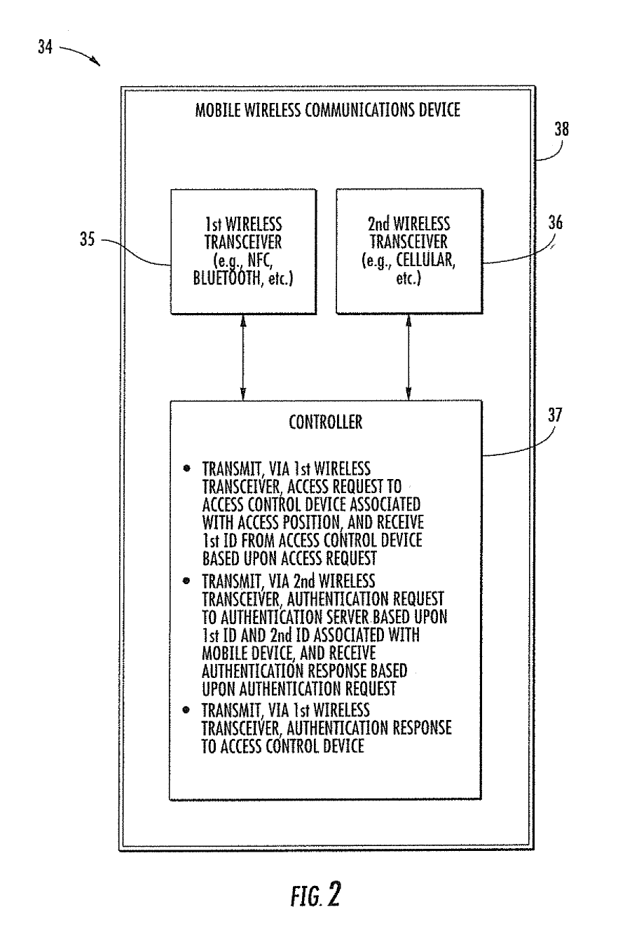

Referring initially to FIGS. 1 through 3, an access system 30 and associated method aspects are first described. The system 30 illustratively includes an access control device 32 (abbreviated “ACD” in FIG. 1) associated with an access position, which in the example of FIG. 1 is a security door 31 that remains locked until the access control device 32 receives a proper authentication to open the security door 31. The system 30 further illustratively includes an authentication server 33, which may be remotely located from the access control device 32 in some embodiments.

More particularly, rather than providing a direct communications link (e.g., via a local area network, cellular link, etc.) between the access control device 32 and the authentication server 33, a mobile wireless communications device 34 (also referred to herein as a “mobile device”) may be used to provide the communications pathway between the access control device 32 and the authentication server 33. This may allow much of the authentication processing and data storage to be performed by a centralized authentication server (or servers) 33 for a plurality of different access control devices 32. Moreover, because a direct communications link may not be required between the access control device 32 and the authentication server 33, deployment of the access control devices 32 may be simpler, quicker, or more cost effective than with a traditional network-based security system, for example.

The mobile device 34 illustratively includes a first wireless transceiver 35 which may be used to communicate with the access control device 32, and a second wireless transceiver 36 which may be used to communicate with the authentication server 33. More particularly, the first wireless transceiver 35 may include a relatively short communication range transceiver, such as a near field communication (NFC) or Bluetooth transceiver, although other suitable communications formats (e.g., TransferJet, wireless LAN, etc.) may also be used in some embodiments.

By way of background, NFC is a short-range wireless communications technology in which NFC-enabled devices may be “swiped,” “bumped” or otherwise moved in close proximity to communicate. In one non-limiting example implementation, NFC may operate at 13.56 MHz and with an effective range of several centimeters (typically up to about 4 cm, or up to about 10 cm, depending upon the given implementation), but other suitable versions of near field communication which may have different operating frequencies, effective ranges, etc., for example, may also be used.

The second wireless transceiver 36 may have a longer communications range associated therewith than the first wireless transceiver. By way of example, the second wireless transceiver 36 may include a cellular transceiver, which may communicate with the authentication server 33 via a wireless communications network 39, such as a cellular network, for example, although other suitable long range wireless communication configurations may also be used.

The mobile device 34 may further illustratively include a controller 37, which may be implemented using a combination of hardware (e.g., microprocessor, etc.) and a non-transitory computer readable medium including computer-readable instructions for causing the various operations discussed herein to be performed. The above-noted components of the mobile device 34 may be carried by a portable housing 38. Example mobile devices 34 may include portable or personal media players (e.g., MP3 players, video players, etc.), remote controls (e.g., television or stereo remotes, etc.), portable gaming devices, portable or mobile telephones, smartphones, etc.

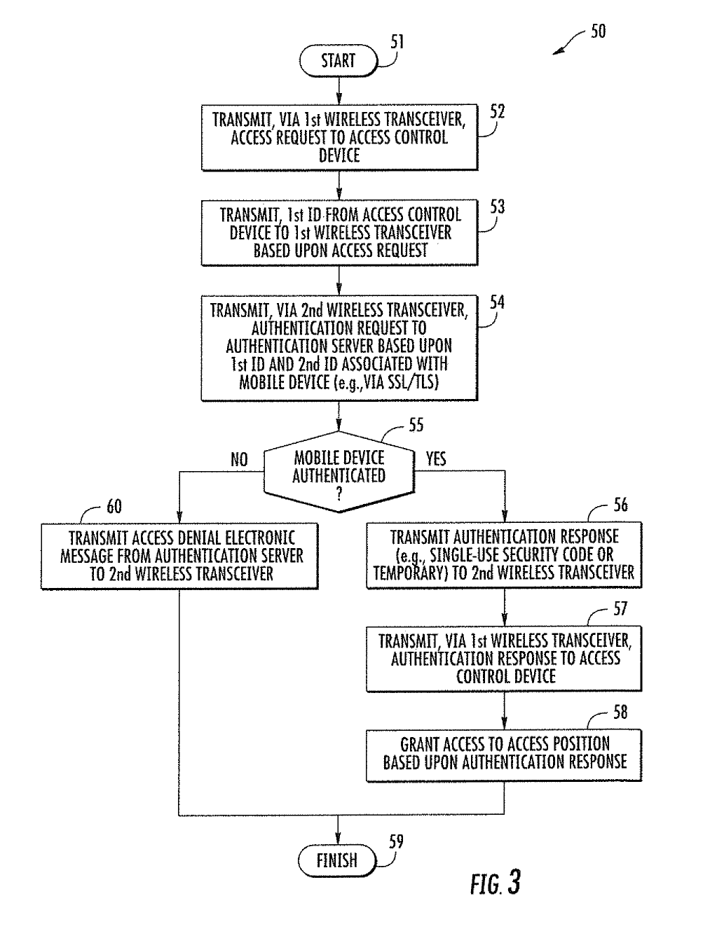

With reference to the flow diagram 50 of FIG. 3, beginning at Block 51, the mobile device 34 is capable of or configured to transmit, via the first wireless transceiver 35, an access request to the access control device 32, at Block 52. For example, if the access control device 32 is an NFC-enabled device and the first wireless transceiver 35 is an NFC transceiver, the access request may be communicated to the access control device 32 upon, for example, swiping or bumping the mobile device 34 with the access control device 32. The access control device 32 is capable of or configured to transmit a first identifier back to the first wireless transceiver 35 based upon the received access request, at Block 53. By way of example, the first identifier may include a security token, key, or other data (which may be encrypted or unencrypted) that uniquely identifies the given access control device 32. The access control device 32 may also optionally communicate an address to the mobile device 34, such as a URL or IP address, for example, at which the authentication server 33 may be accessed. However, in some embodiments the appropriate address or location at which to access the authentication server 33 may already be known to the controller 37, e.g., as a result of prior registration with the authentication server 33.

Upon receiving the first identifier (and optionally the address of the authentication server 33) the controller 37 transmits, via the second wireless transceiver 36, an authentication request to the authentication server 33 based upon the first identifier and a second identifier associated with the mobile device 34, at Block 54. By way of example, the second identifier associated with the mobile device 34 may be a phone number assigned to the mobile device (e.g., by a cellular network carrier), an International Mobile Equipment Identity (IMEI) number, a device personal identification number (PIN), or other types of data which may be used to identify the mobile device 34. In some embodiments, the identifier may uniquely identify the mobile device.

The authentication server 33 is capable of or configured to authenticate the mobile device 34 responsive to the authentication request based upon, for example, the first identifier and the second identifier, at Block 55. More particularly, in some embodiments, the authentication server 33 may include a database of the various access control devices 32 and the mobile devices 34 which are permitted to obtain access to respective access control devices 32. A database query, for example, may be performed to verify that the given mobile device 34 which sent the authentication request is permitted to access the access position associated with the access control device 32 using, for example, the first and second identifiers. In some embodiments, authentication server may also update or maintain a log of the second identifiers used for granting access via the access control device 32. The log may also include, for example, other indications of the mobile device 34 to which access was granted, date/time of access, etc.

If the mobile device 34 is properly authenticated, the authentication server 33 may transmit an authentication response to the mobile device 34 via the second wireless transceiver 36, at Block 56. The controller 37 may transmit, via the first wireless transceiver 35, the authentication response to the access control device 32, at Block 57, and the access control device 32 may be capable of or configured to grant access to the access position based upon the authentication response, at Block 58, which concludes the method illustrated in FIG. 3 (Block 59). If the authentication server 33 is unable to authenticate the mobile device 34 with respect to the given access control device 32, then the authentication server 33 may optionally transmit an access denial electronic message to the mobile device 34 via the second wireless transceiver 36 based upon an authentication failure, at Block 60. The access denial message may optionally include information regarding the denial of access, such as, for example, if access was attempted at an unauthorized time (e.g., after business hours), expiration of a user's account, etc. In some embodiments, the access denial message may be communicated directly to the mobile device 34 as part of the authentication process, or it may be sent separately as an email or SMS message, for example.

The authentication response may include a command, token, or other data which the access control device 32 may recognize as an authorization to provide access to the access position, for example. In some embodiments, the authentication response (or a portion thereof) may be encrypted using, for example, a security key (e.g., a public private key pair) which only the access control device 32 will be able to decrypt, thus preventing the mobile device 34 from being able gain access in the future by circumventing the authentication server 33. In accordance with another example aspect, the authentication response may include a one-time or single-use security code, which the access control device 32 would recognize as being valid to grant access a single time only. In accordance with another example, the authentication response or security code may have an expiration time associated therewith. That is, the authentication response may be valid for a temporary duration, allowing the mobile device 34 to access the access location for a period of time, e.g., an hour, a day, etc. This may be particularly beneficial where the access control device 32 is associated with a shared resource, such as a conference room, etc.

In the example of FIG. 1, access is granted to a user 40 of the mobile device 34 to a room, etc., behind the door 31 (i.e., the room is the access position in this example). Various other examples of access positions that may be protected by the access control device 32 are also possible, such as municipal parks, tool or storage facilities, hydro/power vaults, commercial sites, construction site access, electrically-activated gates, building access, a security gate or turnstile, a secure object such as a safe, locker, vehicle, etc. The system 30 may allow for remote or mobile deployment of the access control device 32, without the necessity for installing a communications architecture (e.g., a wired network connection, a cellular transceiver, etc.) at the access location.

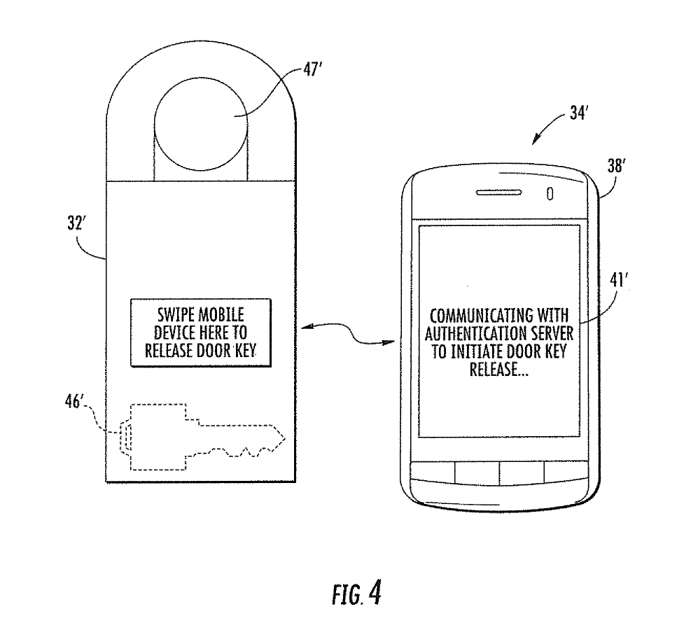

Moreover, the system 30 also may allow for relatively rapid deployment and relocation of access control devices 32. In an example implementation now described with reference to FIG. 4, an access control device 32′ is implemented as a key lock box, such as for real estate agents who need to access a key to show properties. More particularly, the access control device 32′ may be secured to a door knob 47′ (or other suitable location) at the property, and upon receiving proper authentication the access control device 32′ may provide access to a key 46′ for, for example, opening a door to the house, building, etc. In the illustrated example, the mobile device 34′ is a smartphone which illustratively includes a display 41′ carried by the housing 38′. In some embodiments, the display 41′ may be used to provide instructions or a status message with respect to accessing the key 46′.

In some embodiments it may be desirable to grant access further based upon additional authentication data besides the first and second identifiers. For example, the user 40 may be further required to provide biometric data (e.g., fingerprint, iris, retina, etc.), a password or personal identification number (PIN), etc. In one example implementation, when the mobile device 34 is swiped or bumped to begin NFC communication, a prompt may be provided to authenticate the mobile device 34, and the controller 37 may communicate with the authentication server 33 via the second wireless transceiver 36 to thereby provide authentication upon receiving the correct additional authentication information along with the first and second identifiers.

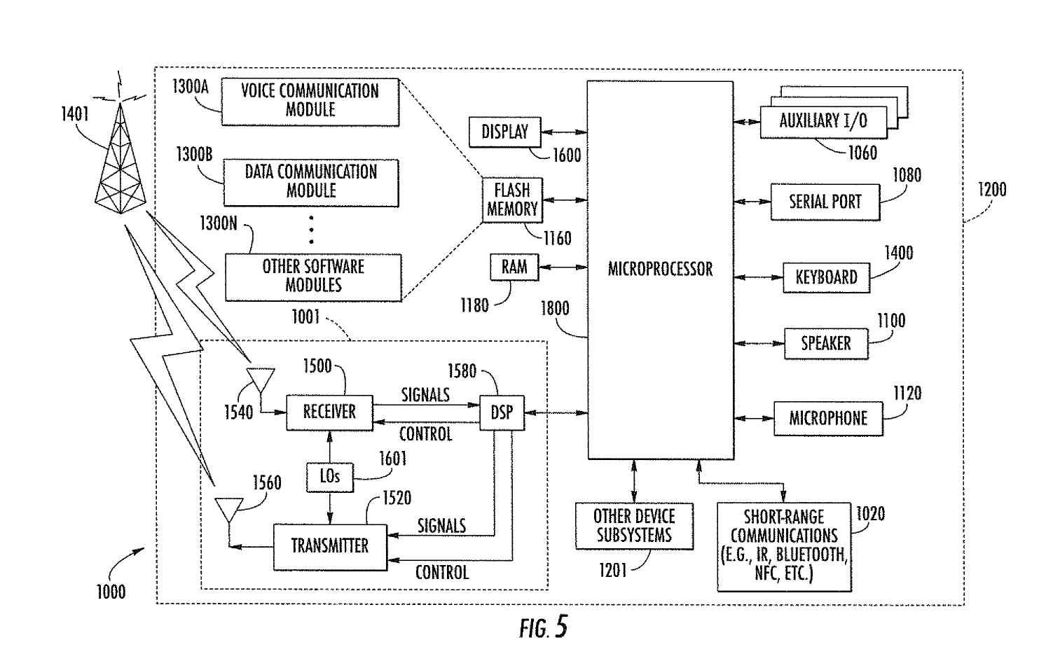

Example components of a mobile communications device 1000 that may be used in accordance with the above-described embodiments are further described below with reference to FIG. 5. The device 1000 illustratively includes a housing 1200, an optional keyboard or keypad 1400 and an output device 1600. The output device shown is a display 1600, which may include a full graphic LCD. In some embodiments, the display 1600 may have an array of touch sensors associated therewith to define a touch screen that may be used an input device. Various types of display technologies may be used, including three-dimensional (3D) displays, in some embodiments. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400.

The housing 1200 may be elongated vertically, or may take on other sizes and shapes (including clamshell housing structures). The keypad may include a mode selection key, or other hardware or software for switching between text entry and telephony entry.

In addition to the processing device 1800, other parts of the mobile device 1000 are shown schematically in FIG. 5. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may include a two-way RF communications device having data and, optionally, voice communications capabilities. In addition, the mobile device 1000 may have the capability to communicate with other computer systems via the Internet.

Operating system software executed by the processing device 1800 is stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications 1300A-1300N on the device 1000. A predetermined set of applications that control basic device operations, such as data and voice communications 1300A and 1300B, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TACT™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as 3GSM, 3GPP, UMTS, 4G, wireless local area network (WLAN) or WiFi, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore typically involves use of a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device may also be used to compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, a Bluetooth™ communications module to provide for communication with similarly-enabled systems and devices, or a near field communications (NFC) communications module for communicating with a NFC device or NFC tag via NFC communications. Other short-range modules may includes a radio frequency identification (RFID) module, a TransferJet module, etc.

Many modifications and other embodiments will come to the mind of one skilled in the art having the benefit of the teachings presented in the foregoing descriptions and the associated drawings. Therefore, it is understood that various modifications and embodiments are intended to be included within the scope of the appended claims.

That which is claimed is:

1. A mobile wireless communications device including:
a first wireless transceiver;
a second wireless transceiver having a longer communication range than the first wireless transceiver; and
a controller coupled with the first wireless transceiver and the second wireless transceiver and capable of
transmitting, via the first wireless transceiver, an access request to an access control device associated with an access position, and receiving a first identifier from the access control device based upon the access request,
transmitting, via the second wireless transceiver, an authentication request to an authentication server based upon the first identifier and a second identifier associated with the mobile wireless communications device, and receiving an authentication response based upon the authentication request, and
transmitting, via the first wireless transceiver, the authentication response to the access control device.

2. The mobile wireless communications device of claim 1 wherein the first wireless transceiver includes a near field communication (NFC) transceiver.

3. The mobile wireless communications device of claim 1 wherein the first wireless transceiver includes a Bluetooth transceiver.

4. The mobile wireless communications device of claim 1 wherein the second wireless transceiver includes a cellular transceiver.

5. The mobile wireless communications device of claim 1 wherein the controller is capable of receiving the first identifier from the access control device along with an address of the authentication server, and sending the authentication request to the address.

6. The mobile wireless communications device of claim 1 wherein the controller is capable of communicating with the authentication server via at least one of a Secure Sockets Layer (SSL) format and a Transport Layer Security (TLS) format.

7. The mobile wireless communications device of claim 1 wherein the authentication response includes a single-use security code.

8. The mobile wireless communications device of claim 1 wherein the authentication response has an expiration time associated therewith.

9. The mobile wireless communications device of claim 1 wherein the controller is capable of receiving an access denial electronic message from the authentication server via the second wireless transceiver based upon an authentication failure.

10. A personnel access system for use with a mobile wireless communication device including a first wireless transceiver and a second wireless transceiver having a longer communication range than the first wireless transceiver, the personnel access system including:
an access control device associated with an access position; and
an authentication server;
the access control device being capable of receiving an access request via the first wireless transceiver of the mobile wireless communications device, and transmitting a first identifier to the first wireless transceiver based upon the access request;
the authentication server being capable of authenticating the mobile wireless communications device responsive to an authentication request received via the second wireless transceiver of the mobile wireless communications device including the first identifier and a second identifier associated with the mobile wireless communications device, and transmitting an authentication response to the second wireless transceiver based upon the authentication;
the access control device being capable of granting access to the access position based upon receiving the authentication response from the mobile wireless communications device via the first wireless transceiver.

11. The personnel access system of claim 9 wherein the access control device is capable of communicating with the first wireless transceiver via near field communication (NFC).

12. The personnel access system of claim 10 wherein the access control device is capable of communicating with the first wireless transceiver via Bluetooth communication.

13. The personnel access system of claim 10 wherein the access control device is capable of transmitting an address associated with the authentication server along with the first identifier to the first wireless transceiver.

14. The personnel access system of claim 10 wherein the access control device includes a key lock box.

15. A method of operating a mobile wireless communications device including a first wireless transceiver and a second wireless transceiver having a longer communication range than the first wireless transceiver, the method including:
transmitting, via the first wireless transceiver, an access request to an access control device associated with an access position, and receiving a first identifier from the access control device based upon the access request;
transmitting, via the second wireless transceiver, an authentication request to an authentication server based upon the first identifier and a second identifier associated with the mobile wireless communications device, and receiving an authentication response based upon the authentication request; and
transmitting, via the first wireless transceiver, the authentication response to the access control device.

16. The method of claim 15 wherein the first wireless transceiver includes a near field communication (NFC) transceiver.

17. The method of claim 15 wherein the first wireless transceiver includes a Bluetooth transceiver.

18. The method of claim 15 wherein the second wireless transceiver includes a cellular transceiver.

19. The method of claim 15 wherein receiving the first identifier further includes receiving the first identifier from the access control device along with an address of the authentication server; and wherein transmitting the authentication request to the authentication server further includes sending the authentication request to the address.

20. A non-transitory computer-readable medium for a mobile wireless communications device including a first wireless transceiver and a second wireless transceiver having a longer communication range than the first wireless transceiver, the non-transitory computer-readable medium having computer-executable instructions for causing the mobile wireless communications device to perform steps including:
transmitting, via the first wireless transceiver, an access request to an access control device associated with an access position, and receiving a first identifier from the access control device based upon the access request;
transmitting, via the second wireless transceiver, an authentication request to an authentication server based upon the first identifier and a second identifier associated with the mobile wireless communications device, and receiving an authentication response based upon the authentication request; and
transmitting, via the first wireless transceiver, the authentication response to the access control device.

21. The non-transitory computer-readable medium of claim 20 wherein the first wireless transceiver includes a near field communication (NFC) transceiver.

22. The non-transitory computer-readable medium of claim 20 wherein the first wireless transceiver includes a Bluetooth transceiver.

23. The non-transitory computer-readable medium of claim 20 wherein the second wireless transceiver includes a cellular transceiver.

24. The non-transitory computer-readable medium of claim 20 wherein receiving the first identifier further includes receiving the first identifier from the access control device along with an address of the authentication server; and wherein transmitting the authentication request to the authentication server further includes sending the authentication request to the address.
